(19) United States
(12) Patent Application Publication
(10) Pub. No.: US 2021/0308727 A1
(43) Pub. Date: Oct. 7, 2021

(54) METHOD AND SYSTEM FOR CLEANING AND FILLING A CYLINDER

(71) Applicant: Kaplan Industries, Inc., Harrison, OH (US)

(72) Inventors: Dean E. Kaplan, Loveland, OH (US); Henry B. Klaus, II, Maple Shade, NJ (US); Paul Stanley O' Neal, Paint Rock, AL (US)

(21) Appl. No.: 17/221,879

(22) Filed: Apr. 5, 2021

Related U.S. Application Data
(60) Provisional application No. 63/006,193, filed on Apr. 7, 2020.

(51) Int. Cl. B08B 9/08

(52) U.S. Cl. CPC B08B 9/0808; B08B 9/0813

(57) ABSTRACT

A method and system for cleaning and filling a pressurizable tank is provided. An inverter is used to advantageously orient the position of the tank through the washing and filling/refilling process. An abrasive whip is used to agitate the interior surface of the tank for agitation of contaminants therein. A high-pressure washer is used to wash the contaminants from the interior of the tank. A vacuum source is used to evacuate the interior of the tank.

This claims the benefit of U.S. Provisional Patent Application Ser. No. 63/006,193, filed Apr. 7, 2020 and hereby incorporated by reference in its entirety.

### FIELD OF THE INVENTION

This invention relates generally to an improved method and system for cleaning and filling a pressurizable vessel, such as a tank or a compressed-gas cylinder.

### BACKGROUND

It is very important that a compressed vessel such as a tank for holding a humanly digestible fluid be carefully and thoroughly cleaned prior to filling or refilling the cylinder for new or recurrent use. Oftentimes, during manufacturing, during shipping, or during use, compressed vessels may become laden with contaminants such as hydrocarbons, oil, metals, or other debris.

Various methods of cleaning have been considered throughout the years. One of the most straightforward ways of cleaning is by filling or partially filling the tank with a commercial cleaning fluid. The tank is then rolled around to cover the inner surface of the vessel in an attempt to clean the tank. The cleaning solution is then washed from the tank and the tank is dried. The tank, cylinder, or pressure vessel is then presumed ready for use. One concern is whether all of the contaminants are thoroughly removed from the tank by these and other such cleaning methods.

Certain substances, fluids and/or gases may present challenges if care is not taken in the cleaning and filling process. For example, pure oxygen is known to be a powerful oxidizer in the presence of fuels. Accordingly, if a tank or pressure vessel is not adequately cleaned, storage and filling of pure oxygen within the tank may become a risky proposition. Hydrocarbons may exist not only on the general inner surface of the pressure vessel, but also within the crevices or micro-defects within the tank. Pure oxygen is known to lower the flash point of hydrocarbons. When not removed from the scratches, dents, crevices, defects, micro-cracks, or other imperfections manifested on and within the inner surface of the tank, the hydrocarbon may be locally available to function as a fuel in the presence of pure oxygen, thereby leading to an unplanned event, either during filling, or perhaps during use of the tank. Pure oxygen, in the presence of a fuel, may therefore potentially cause hazardous conditions that would not normally be possible in regular atmospheric air.

Contaminants within the compressed gas supply may, for example, be taken into the lungs and/or mouth, thereby creating an undesirable and unforeseen reaction in the lungs, mouth, and general airway.

One need for the attention to tank cleanliness has recently arisen in the production of Cannabidiol (CBD) for human consumption. CBD is a compound that has shown promise and beneficial results in a variety of applications, including medical applications. There are many ways to extract the oil from cannabis or hemp and make CBD oil. One exemplary process involves milling the hemp flowers to produce a powder which then may undergo a decarboxylation process to produce a decarboxylated powder. This powder then undergoes an extraction process to produce a crude oil for further processing. The medical cannabis and hemp extraction industry shares similar production requirements to the pharmaceutical and cosmetics sector. Good production processes and clean environments, including the pressurized tanks used in such processes, are crucial to producing a safe final product. To maintain an extraction system for optimal production and avoidance of contamination and downtime, proper cleaning and maintenance of the tanks is important. Proper cleaning is a requirement and will minimize the occurrence of many common problems.

In essence, it remains a challenge to optimize and improve cleaning methods to successfully remove even the smallest amount of contaminants when dealing with gases, fluids or any tank contents that come into contact with humans, either through digestion or the airway and lungs, or through other compressed-gas applications.

### SUMMARY OF THE INVENTION

A system and method for cleaning and filling a pressurizable tank addresses these and other shortcomings in the prior art according to various embodiments of this invention. In some embodiments of this invention, an inverter is used to advantageously orient the position of the tank through a washing and filling/refilling process. Further, an abrasive whip may be used to agitate the interior surface of the tank for agitation of any contaminants therein. This helps to dislodge such contaminants from the inner wall of the tank for removal from the tank. A high-pressure washer may be used to wash the dislodged and other contaminants from the interior of the tank. A vacuum source may then be used to evacuate the interior of the tank according to various embodiments of this invention.

The various methods, installations and systems according to embodiments of this invention are applicable to clean tanks used in the production of CBD oil and provide for appropriate cleanliness of the tank for these and other applications within the scope of this invention.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings. Like reference numerals are used to indicate like parts throughout the various drawing figures, wherein:

FIG. 1 is a view of a first implementation of the tank cleaning method and system of this invention;

FIG. 2 is a view of a block diagram illustrating the cleaning and filling process of a new tank, in accordance with this invention; and

FIG. 3 is a view of a block diagram illustrating the cleaning and refilling process of a used tank, in accordance with this invention.

### DETAILED DESCRIPTION OF THE INVENTION

With reference to the drawings, this section describes particular embodiments and their detailed process, construction, and/or operation. Throughout the specification, reference to “one embodiment,” “an embodiment,” or “some embodiments” means that a particular described feature, structure, or characteristic may be included in at least one embodiment. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

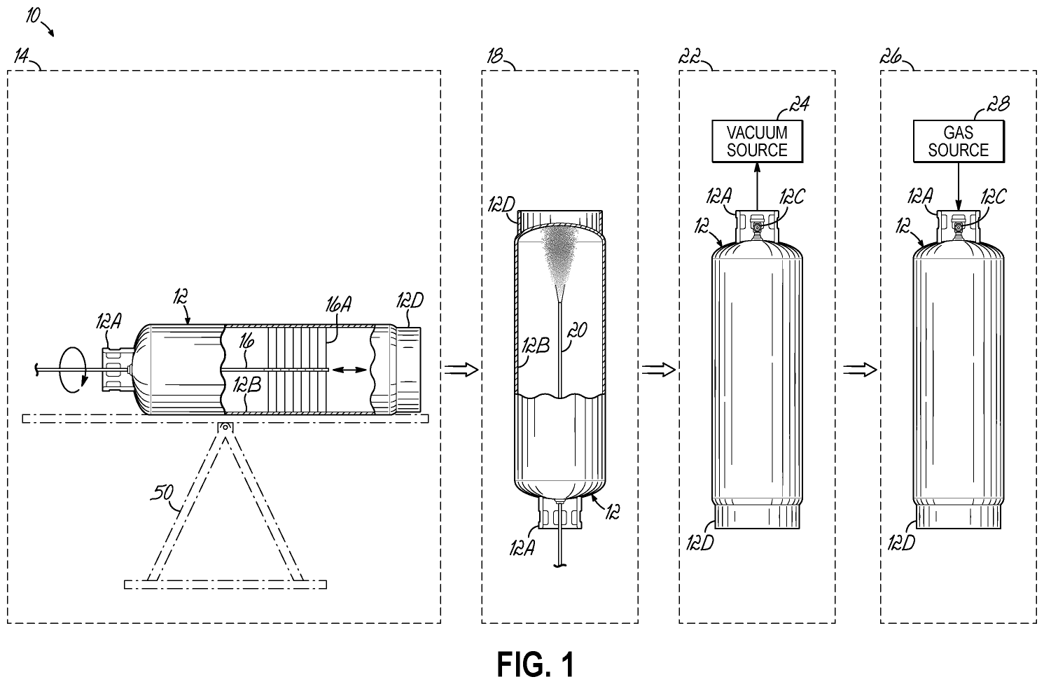

Reference is made first to FIG. 1, which in accordance with this invention, is a schematic view of a first implementation of a tank cleaning method and system 10. The system and method disclosed herein is particularly applicable in the production of CBD oil, but one of ordinary skill will appreciate that this invention is not limited to such processes and methods and has other applications. As generally shown, a tank, cylinder, or pressurized vessel 12 is presented for cleaning and filling. As known in the art, the tank 12 is designed to hold pressurized and compressed gases of various types. Prior to beginning the washing phase of system 10, the tank is inspected for dents or scrapes. Another pre-wash requirement is to remove any plug that would, on new tanks or cylinders, cover an open end 12A. Associated threads formed on the tank 12 (not shown) should also be inspected for wear and defects at this time. With regard to used tanks or cylinders, any tank valve or valve assembly 12C should be removed to access the opening 12A for access to the interior of the tank 12. Again, any associated threads or connective features of the tank 12 should be inspected for defects at this time as well.

In a first step 14, the tank 12 is “inverted” or stated another way, laid in a generally horizontal position for an initial agitation step. An inverter 50 is used to orient the pressurizable tank, cylinder, or vessel 12 to the desired position. Yet further, in washing step 18, the inverter 50 orients the tank 12 in an upside-down vertical position for efficient drainage of the tank 12 during the washing step 18. And finally, in vacuum step 22 and filling/re-filling step 26, the inverter 50 orients the tank 12 in a right-side up position for each of those steps.

A wire whip 16, containing collapsible whipping members 16A, is inserted through the opening 12A on one end of the tank 12 as part of the first step 14. The term, “collapsible” is meant to convey that the whipping members when relaxed may hang limply from the wire whip 16, but when operably rotated with a drill, for example, may extend radially outwardly from the wire whip 16. As shown in FIG. 1, when rotatably operated by an electric, pneumatic or otherwise-powered drill, for example, the braided stainless-steel cable brush or wire whip members 16A centrifugally extend to scrub and agitate the inner surface 12B of the tank 12. As the wire whip 16 is iteratively moved across the length, or from one end of the tank to another, contaminants from depositions within defects or imperfections on the inner surface 12B, or as electrostatically adhered to the surface, are thereby agitated and dislodged from their respective seats. Yet further, heavier soils and rust, or any excessive slag metal from a manufacturing process, for example, may also be removed by the whipping of members 16A across the length of the inner annular surface 12A.

Reference is again made to FIG. 1, and as schematically shown in step 18 and after agitation step 14, the tank 12 is then washed. The tank 12 may be inverted to a vertical position with the closed end 12D of the tank being oriented upwardly of the open end 12A. The washing or cleaning step may be accomplished with known cleaners and sprayed or otherwise applied to remove any agitated residue or contaminants from step 16. For example, light soils may be removed with hot water—the hotter the water, the easier it will be to dry the heated inner surface 12B of the tank 12. Or, if grease, oil, and/or lubricants are deposed about the inner surface 12B, then light detergent mixed with hot water may be mixed and applied from a pressure washer for example, in an amount sufficient to completely cover the inner surface 12B for removal of such contaminants. When soap is used, an oxygen-compatible soap may be used, such as Blue & Gold Soap by Modern Chemical, for example. As also shown, a high-pressure hose 20 may be used in the washing step to further impinge on the surface 12B for effective removal of the dirt.

Whatever the dirt load, the washing step 18 may be conducted with hot water at about 180 degrees Fahrenheit, and with a relatively high-pressure impingement of the interior surface 12B by the washing spray for at least a minute. Then, if soap is used, the soap is injected into the pressurized hot water, and sprayed for about thirty seconds or more.

Afterwards, and further to the washing step 18, the inner surface 12B is thoroughly rinsed with hot water (at about 180 degrees Fahrenheit and for at least a minute in one exemplary embodiment) to remove all debris, contaminants, and/or soap, again using a high-pressure hose 20 if desired to further impinge on the surface 12B for effective removal of the dirt. The rinsing step may be repeated until all soap, debris, and grime are removed from the interior of the tank.

Next, the inner surface 12B of the wet inverted tank 12 may be air-dried with a relatively high-pressure air at about 180 PSI. Filtered air may be used to ensure that no contaminants are contained within the air used to dry the inner surface. The relatively high-pressure air is blown into the tank interior for at least a minute. Then, the tank 12 may be rotated at various horizontal to vertical positions to ensure that no water or fluids build or collect at the effective bottom side of the tank 12 during the washing step. The tank 12 is then again inverted into an upside-down vertical position and again air-dried as described above. The complete drying process as described herein, may be conducted at least three times.

The inner surface 12B is then removed from the drying phase or step and inspected for moisture. An Opti-light or other suitable light such as an LED light source may be used to identify any spots or moisture that remains. Any remaining moisture or spots are spot-dried with a drying gas, which may be nitrogen, by blowing it into the tank 12 and then evacuating the drying gas. The tank 12 may then again be inspected in the same way for moisture and the nitrogen spot cleaning continued until no moisture is identified. Ultimately, the inside of the tank 12 is inspected after washing to ensure a clean and dry interior.

Prior to a vacuum step 22, the valve or valve assembly 12C is replaced (after appropriate cleaning and reconditioning) or refurbished as needed. In general, the threads, the shell, and the inside of the tank 12 are again inspected for any defects or dirt/contaminants and the appropriate corrective measures are taken if necessary. For example, if the threads are found to be defective, then the threads are re-tapped as necessary, and the threaded surface is thereafter carefully cleaned to ensure that no contaminants are introduced into the tank 12 as it is later being filled. For a new tank 12, a 510 Ceodeux valve provided by Rotarex for example, may be installed on the cylinder. For older tanks and valves, either the same type of new valve if necessary, or a refurbished/reconditioned valve as indicated above, may be installed. As known in the art, a stainless steel dip tube (not shown) may be connected to the valve. If the valve is new, then a new dip tube may also be provided. If the valve is reconditioned, then the dip tube is washed and individually cleaned with a similar process as provided for the tank 12 above. The valve connection or connective junction (not shown) may be sealed with 8 Polytetrafluoroethylene (PTFE) thread sealer. The valve connection is then torqued to specification, on a valving machine for example, to no more than five threads and no less than two threads.

Upon completing the valve installation, nitrogen is connected to the valve and the tank 12 is pressurized to about 200 psi. Leak checks may then be conducted with Ratermann leak detection compound, provided by Ratermann Manufacturing, Inc., for example. The threads and safety valves are also inspected by magnifying glass to ensure that there are no leaks. If any leaks are detected, remedial and/or corrective action, such as re-tapping of threads and a repeat of the valving procedure is conducted. If leaks are still detected the valve and/or the tank are removed as defective. Upon completion of a successful leak check, the nitrogen is released from the tank 12.

Again, with reference to FIG. 1, a vacuum step 22 contains a vacuum source 24, whereby the vacuum source 24 is connected to the valve 12C to evacuate any air, nitrogen, or other possible contents within the tank 12. A brass fitting (not shown) may couple the vacuum source 24 to the valve 12C. The vacuum is used, for about two hours, to evacuate the interior of the tank 12 such that the tank is readied or prepared to receive a full complement of the mass capacity of whatever gas is going to be injected therein. After two hours, the valve 12C is closed before removing the tank 12 from the vacuum source 24. The tank 12 may then, for example, be labelled or certified, such as “Cleaned” or “Tank and Valve Have Been Cleaned for Service”, or the like and then shelved for future use.

Thereafter, and again as shown in FIG. 1, a filling or re-filling step 26 is schematically exemplified. A gas source 28 fluidly communicates with valve assembly 12C thereby facilitating gas pressurization and filling/re-filling of the tank 12. In the overall process 10, and in the filling/re-filling step 26, all safety requirements are adhered to.

Thereafter, the tank is labelled, stenciled, wrapped, and otherwise readied for shipment in accordance with industry guidelines, F.D.A., D.O.T. and/or other regulatory requirements, and so forth.

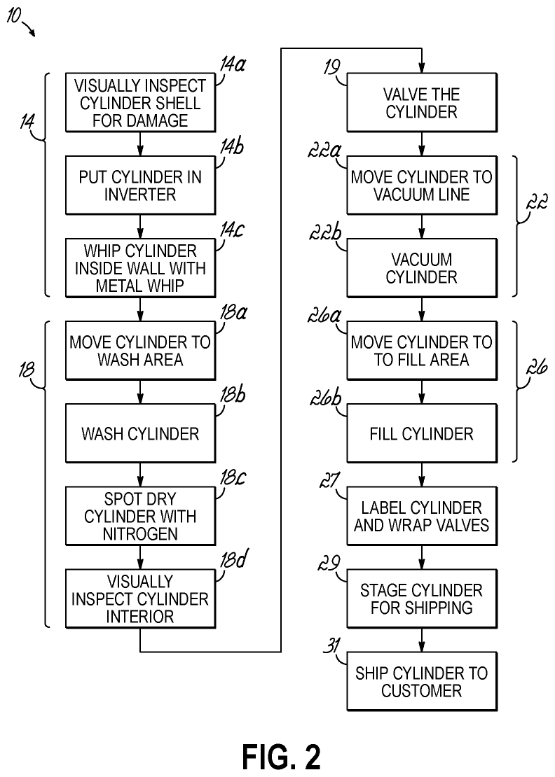

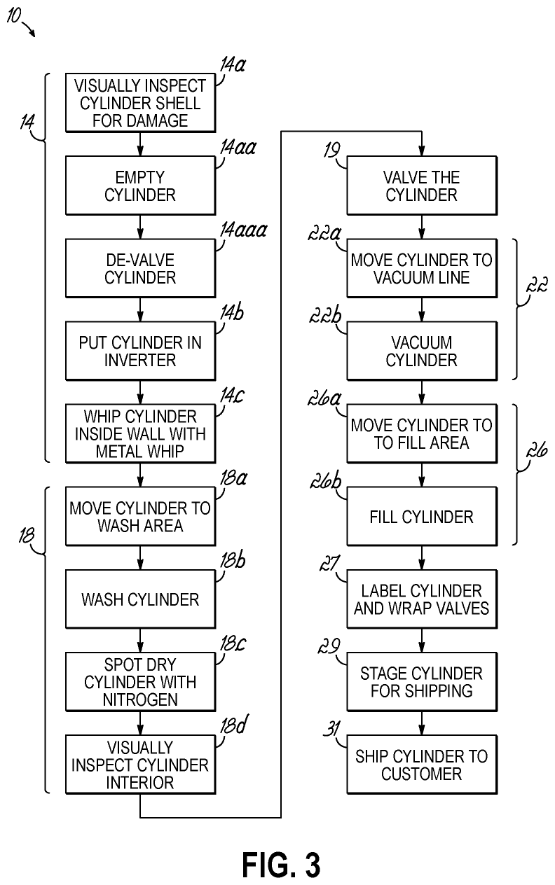

With reference to FIG. 2, a block diagram is presented that schematically exemplifies a wash and fill process 10 for a new tank or tank 12 according to various embodiments of this invention. With reference to FIG. 3, a block diagram is presented that schematically exemplifies a wash and re-fill process 10 for a used, refurbished, and/or reconditioned tank or tank 12 according to various embodiments of this invention.

According to the methods shown in FIGS. 2-3, the tank 12 is initially visually inspected 14a for damage. In the process of FIG. 3, the used tank 12 is emptied 14aa and the old valve assembly is removed 14aaa from the tank 12. In step 14b of FIGS. 2-3, the inverter 50 orients the tank 12 in a generally horizontal position. In step 14c, the abrasive member or wire whip 16 may contain one or more wire whip collapsible member(s) 16A, may be made from braided stainless steel. One such applicable to various embodiments of this invention is wire whip 16 is available from https://cylindertrainingservices.com/ as a tank cleaning whip, SKU 03-0017-20. When inserted within tank 12 and rotatably powered, such as by an electric, pneumatic or otherwise powered drill for example, the wire whip collapsible member(s) 16A are centrifugally forced into abrasive communication with the interior surface 12B of the tank 12 as the wire whip is negotiated across the inner length and inner diameter of the tank 12. In this way, metal tags or burrs from the manufacturing process, dirt, oil, hydrocarbons, and other contaminants, those electrostatically or otherwise adhered to the inner surface 12B and those recessed into the crevices, defects, micro-scratches, scratches, dents, or other surface anomalies of the tank 12, are sufficiently agitated for removal from the tank 12. Other abrasive whips 16 are contemplated, so long as they are made from an abrasive and tough composite of materials or metal, able to withstand the relatively high temperatures of abrasion.

In washing step 18, the tank 12 is moved 18a to a wash area. A pressurized washer 20 provides relatively high-pressure water and washing solvent to the tank 12 for washing and cleaning 18b thereof. A drying system (not shown) using relatively high-pressure filtered atmospheric air, and nitrogen if desired, may be plumbed into the cleaning line for use in the washing step 18 to spot dry 18c the tank 12. Further visual inspection 18d may be conducted to identify any issues with the washing and drying steps for possible further cleaning and/or drying. Next, the tank or cylinder 12 may have a valve assembly 12C installed in step 19 as previously described.

In vacuum step 22, the tank 12 is moved 22a to a vacuum line. A vacuum source 24 is provided to fluidly communicate with a sealed and valved tank 12, thereby providing evacuation 22b of the tank 12.

In filling/re-filling step 26, the tank 12 may be moved 26a to a filling area. Then a gas source 26 is provided to fluidly communicate with the sealed and valved tank 12, thereby filling 26b the tank 12 to provide a full reservoir of a mass capacity of desired gas to the tank 12.

Once filled, the tank 12 may be labeled and the valve wrapped 27 as previously noted. The tank 12 may then be staged 29 as needed with similar tanks prior to shipment 31 to the customer.

While this invention has been described in conjunction with a number of embodiments, those skilled in the art will recognize that certain modifications to the described embodiments still fall within the spirit and scope of the invention. Accordingly, the scope of this invention is not meant to be limited by the disclosure herein, but may be modified while maintaining its novel process and construction, as would be apparent to one of ordinary skill in the art.

What is claimed is:

1. A method of cleaning a pressurizable tank, the method comprising the steps of:
positioning the tank to a horizontal orientation;
inserting an abrasive member into an interior volume of the tank through an opening defined at a longitudinal end of the tank;
contacting an inner surface of the tank with the abrasive member;
positioning the tank to a substantially vertical orientation with the opening directed downwardly;
washing the inner surface of the tank;
drying the inner surface of the tank;
installing a valve onto the opening in the tank;
evacuating interior volume of the tank to produce at least a partial vacuum therein; and
closing the valve to seal the interior volume of the tank under the at least partial vacuum.

2. The method of claim 1 wherein the drying step further comprises:
injecting nitrogen into the interior volume of the tank.

3. The method of claim 2 wherein the drying step further comprises:
spot drying selected areas of the inner surface of the tank with the nitrogen.

4. The method of claim 1 wherein the contacting step further comprises:
rotating the abrasive member within the interior volume and against the inner surface.

5. The method of claim 1 further comprising:
visually inspecting the inner surface after the drying step.

6. The method of claim 1 further comprising:
visually inspecting an exterior of the tank for damage.

7. The method of claim 1 further comprising:
labeling the tank after the closing step.

8. The method of claim 1 further comprising:
wrapping the valve assembly after the closing step.

9. The method of claim 1 further comprising:
removing an old valve assembly from the tank prior to the inserting step.

10. The method of claim 1 further comprising:
filling the interior volume of the tank via the valve assembly with a desired fluid.

11. A method of cleaning a pressurizable tank, the method comprising the steps of:
positioning the tank to a horizontal orientation;
inserting an abrasive member into an interior volume of the tank through an opening defined at a longitudinal end of the tank;
contacting an inner surface of the tank with the abrasive member by rotating the abrasive member within the interior volume and against the inner surface;
positioning the tank to a substantially vertical orientation with the opening directed downwardly;
washing the inner surface of the tank;
drying the inner surface of the tank by injecting nitrogen into the interior volume of the tank;
visually inspecting the inner surface after the drying step;
installing a valve onto the opening in the tank;
evacuating interior volume of the tank to produce at least a partial vacuum therein;
closing the valve to seal the interior volume of the tank under the at least partial vacuum;
labeling the tank after the closing step; and
wrapping the valve assembly after the closing step.

12. The method of claim 11 wherein the drying step further comprises:
spot drying selected areas of the inner surface of the tank with the nitrogen.

13. The method of claim 1 further comprising:
removing an old valve assembly from the tank prior to the inserting step.

14. The method of claim 1 further comprising:
filling the interior volume of the tank via the valve assembly with a desired fluid.

15. The method of claim 1 wherein the method is employed in the extraction of cannabis oil.

16. A system for cleaning a pressurizable tank, the system comprising:
an inverter for positionally orienting the tank;
an abrasive whip for rotatably providing an abrasive force against an interior of the tank;
a pressurized washer for washing the interior of the tank; and
a vacuum for evacuating the interior of the tank.
